(19) United States
(12) Patent Application Publication
(10) Pub. No.: US 2018/0191712 A1
(43) Pub. Date: Jul. 5, 2018

(54) Preventing Unauthorized Access to Secured Information Systems Using Proactive Controls

(71) Applicant: Bank of America Corporation, Charlotte, NC (US)

(72) Inventors: Eduardo J. Ramirez, Wilmington, DE (US); Craig Widmann, Chandler, AZ (US); Amijo Bearley, Oxford, PA (US); Robert D. Jones, Wilmington, DE (US); Aron Megyeri, Kennett Square, PA (US)

(21) Appl. No.: 15/396,899

(22) Filed: Jan. 3, 2017

(51) Int. Cl. H04L 29/06

(52) U.S. Cl. CPC H04L 63/0861; H04L 63/1408

(57) ABSTRACT

Systems and arrangements for detecting unauthorized activity and implementing proactive controls to avoid future occurrences of unauthorized activity are provided. The system may receive one or more occurrences of unauthorized activity and may identify similar pairs of occurrences. The pairs of occurrences may then be compared to generate occurrence clusters. The occurrence clusters may be analyzed to determine a common merchant or other attribute. This common merchant or other attribute may be used to query a database to identify one or more devices also associated with the merchant or attribute. One or more proactive controls may then be implemented on the identified devices.

### BACKGROUND

Aspects of the disclosure relate to computer hardware and software. In particular, one or more aspects of the disclosure generally relate to computer hardware and software for detecting unauthorized activity and implementing one or more proactive controls.

Use of devices to conduct or process events (e.g., purchase made in stores, online, or the like) may leave a user susceptible to having data or other information from the device used in unauthorized activity. For instance, unauthorized users may obtain an account number, device number, or the like, and may use the device for processing unauthorized events. Accordingly, entities, such as entities issuing devices, are often looking for ways to prevent unauthorized activity before it happens, but also to mitigate potential damage resulting from unauthorized activity.

Upon an occurrence of unauthorized activity, a user will typically report the occurrence (e.g., submit a claim) to the entity issuing the device. However, because of the volume of occurrences being received each day, week, month, or the like (e.g., millions of occurrences may be reported), entities are often unable to evaluate each individual occurrence to determine whether unauthorized activity has occurred or to identify preventative measures to avoid future occurrences. Accordingly, it would be advantageous to have a system in which occurrences are grouped by commonalities in order to reduce a number of occurrences being evaluated and also to more quickly and efficiently implement controls to avoid or prevent future unauthorized activity.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to computer systems and arrangements for detecting unauthorized activity and implementing proactive controls to avoid future occurrences of unauthorized activity. In some examples, the system may receive one or more occurrences of unauthorized activity and may identify a plurality of events associated with each occurrence of unauthorized activity. In some arrangements, the system may generate a data structure including each occurrence and each event associated with each occurrence.

In some examples, the system may compare each occurrence to each other occurrence to determine a similarity rating between the two occurrences. The similarity rating may be compared to a first similarity threshold and, if the similarity rating is within the first threshold, the occurrences may be paired. This process may continue until each occurrence has been compared to each other occurrence. Any occurrences that are not paired at the conclusion of the comparison may be removed from further processing.

In some examples, the pairs of occurrences may then be compared to other pairs or individual occurrences to determine a second similarity rating. If the second similarity rating is within a second predetermined threshold, the occurrences may be joined in an occurrence cluster. This process may be repeated until each pair is compared to each other pair or each other occurrence.

In some arrangements, the occurrence clusters may be analyzed to determine a common merchant or other attribute. This common merchant or other attribute may be used to query a database to identify one or more devices also associated with the merchant or attribute. One or more proactive controls may then be implemented on the identified devices.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative unauthorized activity detection and control computing device according to one or more aspects described herein;

FIGS. 2A-2E depict an illustrative event sequence for detecting unauthorized activity and implementing proactive controls according to one or more aspects described herein;

FIGS. 3A and 3B depict one example method of detecting unauthorized activity and implementing proactive controls according to one or more aspects described herein.

FIG. 4 illustrates one example user interface that may be generated and displayed to a user at a computing device according to one or more aspects described herein.

FIG. 5 illustrates another example user interface that may be generated and displayed to a user at a computing device according to one or more aspects described herein.

FIG. 6 illustrates one example operating environment in which various aspects of the disclosure may be implemented in accordance with one or more aspects described herein; and

FIG. 7 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, conventional systems for detecting unauthorized activity often involve researching each individual occurrence of unauthorized activity. Given that an entity may receive a vast number of occurrences of unauthorized activity in a particular time period, it may be virtually impossible to research each individual occurrence, let alone research each occurrence in a timely manner in order to proactively reduce or eliminate a threat of additional occurrences (e.g., by the same individual, using the same device in an unauthorized manner, or the like). Accordingly, systems and arrangements described herein provide a more efficient and accurate way to evaluate occurrences of unauthorized activity and enable earlier detection of potential future occurrences of unauthorized activity. This allows for one or more proactive steps to be taken in order to reduce or eliminate the potential future unauthorized activity.

As discussed more fully herein, systems, devices, and arrangements described herein are related to receiving one or more occurrences of unauthorized activity and receiving and/or identifying one or more events associated with each occurrence of unauthorized activity. In some examples, each occurrence may be compared to each other occurrence to determine a similarity score or value for the comparison of one occurrence to one other occurrence. The similarity score or value may be compared to a first predetermined similarity threshold. If the similarity score or value is within the threshold (e.g., at or above the threshold) the occurrences being compared may be paired. The process may be repeated until each occurrence has been compared to each other occurrence. In some examples, occurrences that are not within the similarity threshold of any other occurrences may be removed from further processing.

In some examples, the pairs of occurrences may then be compared to other pairs and/or other individual occurrences. A similarity score or value may be determined and compared to a second predetermined similarity threshold. If the similarity score or value is at or above the threshold, the pairs or pair and other occurrence may be grouped in an occurrence cluster. The process may be repeated until a desired number of clusters is achieved. In such an arrangement, the number of items to evaluate for unauthorized activity may be drastically reduced (e.g., from evaluating each individual occurrence).

In some arrangements, each occurrence cluster may be evaluated to identify a common merchant or other attribute. The common merchant or attribute may then be used as input in a query to identify one or more other devices that may have been used at that merchant or may have a similar or same attribute. These devices may be flagged as having potential for future occurrences of unauthorized activity and one or more proactive controls may be implemented. For instance, a limit may be placed on an amount that may be transacted using the identified device. In another example, additional identifying or authenticating information may be required to process a transaction or event with the device. In still other examples, the device may be canceled or deactivated and a substitute or replacement device may be issued to the user.

These and various other arrangements will be discussed more fully herein.

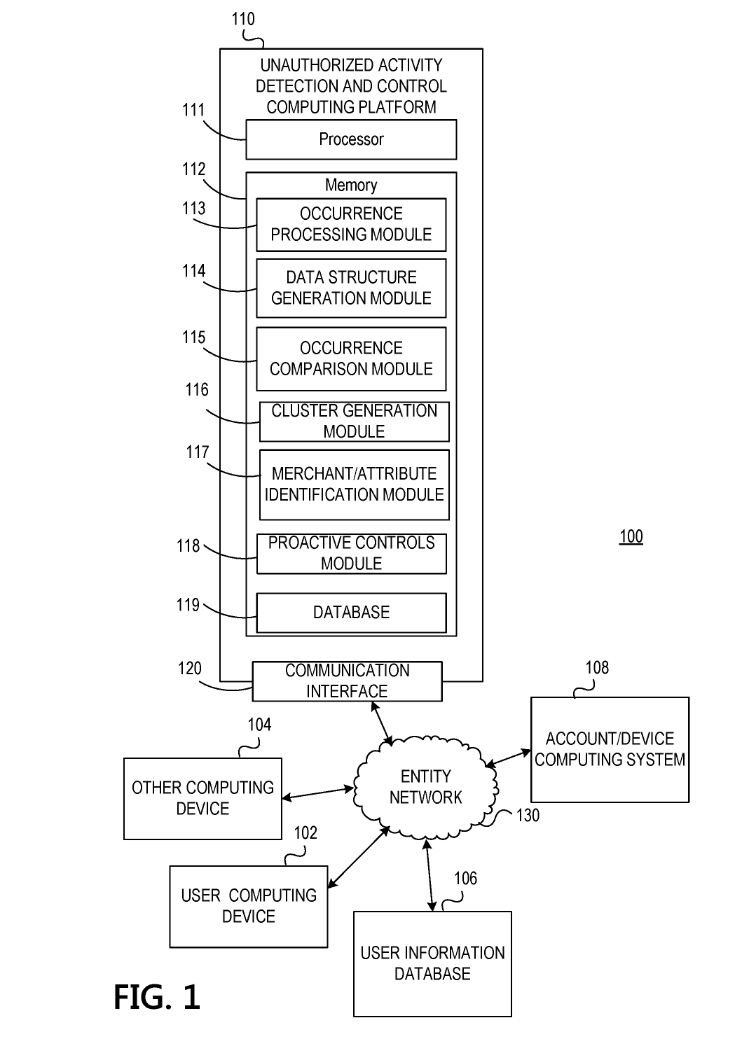

FIG. 1 depicts an environment 100 including an illustrative computing platform for detecting unauthorized activity and implementing proactive controls according to one or more aspects described herein. For instance, the environment 100 includes an unauthorized activity detection and control computing platform 110, which may include one or more processors 111, memory 112, and communication interface 120. A data bus may interconnect processor(s) 111, memory 112, and communication interface 120. Communication interface 120 may be a network interface configured to support communication between device functionality and event processing computing platform 110 and one or more wired and/or wireless networks (e.g., network 130). One or more computing or other devices or systems 102, 104, 108 may be in communication with the unauthorized activity detection and control computing platform 110 (e.g., via network 130). One or more databases 106 may also be connected to or in communication with the unauthorized activity detection and control computing platform 110 via one or more networks, such as network 130. The computing devices shown in FIG. 1 (e.g., computing platform 110, user computing device 102, other computing device 104, account/device computing system 108, and the like) may be special purpose computing devices configured to perform specific functions, as illustrated in greater detail below, and may include specific components such as processors, memories, communication interfaces, and/or the like.

For instance, unauthorized activity detection and control computer platform 110 may be configured to monitor events and occurrences, such as transactions, claims of unauthorized activity, and the like, to identify occurrences of unauthorized activity, identify similarities between various occurrences of unauthorized activity, and proactively control occurrences of potential unauthorized activity. For instance, the unauthorized activity detection and control computing platform 110 may identify devices, such as credit cards, debit cards, and the like, that may be at risk for potential unauthorized activity and may modify (or direct and control another device to modify) one or more parameters associated with the devices (e.g., an event or transaction limit, a requirement for additional authenticating information, or the like) and/or may proactively cancel the device and issue a substitute device to a user.

Memory 112 may include one or more program modules having instructions that when executed by processor(s) 111 cause the unauthorized activity detection and control computing platform 110 to perform one or more functions described herein, and/or one or more databases 119 that may store and/or otherwise maintain information which may be used by such program modules and/or processor(s) 111. In some instances, the one or more program modules and/or databases may be stored by and/or maintained in different memory units of unauthorized activity detection and control computing platform 110 and/or by different computer systems or devices that may form and/or otherwise make up the unauthorized activity detection and control computing platform 110. In some arrangements, different features or processes performed may be performed by different sets of instructions, such that the processor may execute each desired set of instructions to perform different functions described herein.

Further, in some examples, the unauthorized activity detection and control computing platform 110 may be part of one or more other computing devices or systems, such as computing device 102, 104, computing system 108, or the like. That is, the unauthorized activity detection and control computing platform 110 may be a device separate from computing devices 102, 104, or computing system 108, and the like, and connected to or in communication with one or more of those devices or system, or the unauthorized activity detection and control computing platform 110 may be part of a same device as one or more of devices 102, 104, or computing system 108, or the like.

Memory 112 may include an occurrence processing module 113. The occurrence processing module 113 may include hardware and/or software configured to perform various functions within the unauthorized activity detection and control computing platform 110. For instance, the occurrence processing module 113 may receive one or more occurrences of unauthorized activity, such as a claim of unauthorized activity on an account, payment device, or the like, and may process the occurrence. In some arrangements, the occurrences may be received from a user reporting unauthorized activity. For example, a user may report an occurrence of unauthorized activity via a user computing device 102, which may include various types of devices, such as laptop devices, tablet devices, desktop devices, smartphones, and the like. The report may be made via an online system or application executing on the computing device 102. In some examples, the report of unauthorized activity may be made via another system, such as a call center computing system, an associate at a financial institution, or the like. Accordingly, the occurrence may be received from other computing device 104 which may include various computing devices, systems, and the like, associated with an entity providing the device or account on which the unauthorized activity has occurred. In other examples, the occurrence may be identified by the computing platform 110 based on attributes associated with other unauthorized activity.

In some examples, processing an occurrence may include identifying one or more events or transactions associated with the occurrence. For instance, if a user reports an occurrence of unauthorized activity on a particular payment device, such as a credit card or debit card, the occurrence processing module 113 may identify one or more other transactions associated with the payment device and may identify one or more transactions that were unauthorized. In some examples, the other events or transactions may be received with the report of the occurrence. In other examples, the system may query one or more databases (e.g., database 119, user information database 106, or the like) to obtain event information.

Unauthorized activity detection and control computing platform 110 may also include a data structure generation module 114. The data structure generation module 114 may include hardware and/or software configured to perform particular functions within the unauthorized activity detection and control computing platform 110. For instance, the data structure generation module 114 may generate one or more data structures (e.g., within database 119) that may include the occurrences, events, and the like, received by and/or processed by the occurrence processing module 113. Accordingly, the data structure may include some or all received occurrences of unauthorized activity and some or all of the unauthorized events associated with each occurrence.

Memory 112 may further include an occurrence comparison module 115. The occurrence comparison module 115 may compare each occurrence (e.g., each occurrence in data structure) to each other occurrence stored in the data structure to identify occurrence that are similar (e.g., are within a first predefined similarity threshold). For instance, each event associated with each occurrence may be analyzed to identify various attributes associated with each event and each occurrence, such as a merchant associated with the event, an amount of the event, a type of merchant associated with the event (e.g., a merchant category code of the merchant), and the like. Each occurrence may then be compared to each other occurrence to determine a level of similarity between occurrences.

For example, in some arrangements, the attributes for each transaction associated with an occurrence may be compared to attributes for each transaction associated with each other occurrence. For each attribute in a first occurrence that matches (or is sufficiently similar to) an attribute in another occurrence (e.g., a second occurrence to which the first occurrence is being compared), a value of one may be indicated. The indicated values of one may then be summed to determine a similarity score or value for the first occurrence and the second occurrence. The similarity score or value may then be compared to a first predetermined similarity threshold. If the similarity score or value is at or above the first predetermined similarity threshold, the first occurrence and the second occurrence may be deemed sufficiently similar and may be paired. Pairing of the first occurrence and the second occurrence may include modifying the data structure to include an indication of the pairing, the determined similarity score or value, and the like.

In some examples, a weighting factor may be used in determining the similarity score. For instance, one or more attributes may be deemed more likely to indicate unauthorized activity. For example, if a merchant name in a first occurrence matches a merchant name in a second occurrence, that may be deemed a likely indicator of unauthorized activity and a weighting factor (e.g., a value greater than one, such as 1.1, 1.2, 1.5, 2.0, or the like) may be multiplied by the value of one to increase an importance of that particular attribute.

In some examples, the initial comparison of occurrences may be performed based on geographic region. For instance, occurrences within a particular region (e.g., based on city name, state, zip code, predetermined distance from a first occurrence, or the like) may be compared to aid in determining similarity and/or pairing occurrences.

The process of comparing occurrences may continue until each occurrence has been compared to each other occurrence and occurrences having similarity scores above the first predetermined threshold have been paired. In some examples, a particular occurrence may be paired with multiple other occurrences based on similarity scores. Those occurrences may then be combined into occurrence clusters, as will be discussed more fully below.

In some examples, any occurrences not found to be similar to another occurrence (e.g., after comparison to each other occurrence is not paired with any occurrences) may be removed from further processing in order to streamline the process and conserve computing resources. Removing from further processing may include deleting the occurrence to moving the occurrence to another data store for further storage.

Memory 112 may include a cluster generation module 116. The cluster generation module 116 may include hardware and/or software configured to perform various functions within the unauthorized activity detection and control computing platform 110. For instance, the cluster generation module 116 may receive pairs of occurrences from the occurrence comparison module 115 and may compare each occurrence to each pair of occurrences In some examples, each pair of occurrences may be compared to each other pair of occurrences to evaluate similarities between the pairs. The pairs may be compared using a process similar to the comparison process for each occurrence. For example, attributes of each occurrence in a pair may be compared to attributes of each occurrence in a second pair to determine a similarity score. If a score for the pair of occurrences (or one occurrence of the pair) is greater than a second predetermined similarity threshold, the pairs (or one pair and one additional occurrence) may be declared an occurrence cluster. The occurrence cluster may be stored in the data structure (e.g., the data structure may be modified to include the newly created cluster).

The comparison of pairs of occurrences may be repeated until each pair of occurrences has been compared to each other pair of occurrences. In some examples, the process may continue with clusters being compared to each other cluster. Such an arrangement allowed the system to efficiently reduce a number of occurrences (or data associated therewith) to be evaluated by identifying groups of occurrences having similarities and focusing resources on the clusters having a large number of occurrences.

The clusters may then be evaluated by a merchant/attribute identification module 117. The merchant/attribute identification module 117 may include hardware and/or software configured to perform various functions within the unauthorized activity detection and control computing platform 110. For instance, the merchant/attribute identification module 117 may identify attributes that are common among occurrences within a cluster. For instance, a particular cluster may have occurrences having events conducted at a same merchant or merchant location. In another example, a particular cluster may have occurrences having events conducted at a same type of merchant or merchant within a same merchant category code. In some examples, a rate of unauthorized activity for the identified merchant or type of merchant within the cluster may be compared to an overall rate of unauthorized activity for the merchant or type of merchant (e.g., for all occurrences not just those in the cluster) or compared to an expected rate of unauthorized activity for the merchant or type of merchant (e.g., based on historical data, or the like). In some examples, the overall rate for the merchant or type of merchant, or the expected rate, may vary by region. For instance, different regions may have different rates of unauthorized activity (e.g., due to differences in number of people within a region, merchants within a region, and the like). Accordingly, comparisons may be made by region in order to increase the accuracy of the comparison. If the rate within the cluster is higher than the overall rate or expected rate, the merchant or merchant type may be flagged by the system for further processing and evaluation.

Further processing may include implementing one or more proactive controls by the unauthorized activity detection and control computing platform 110. For instance, the computing platform may include a proactive controls module 118 that may include hardware and/or software configured to perform various functions within the unauthorized activity detection and control computing platform 110. The proactive controls module 118 may receive merchants or merchant types flagged by the merchant/attribute identification module 117 and may use the name or type of merchant as input in a database query. For instance, the proactive controls module 118 may query a database 106 which may include user information, account information, event information, device information, and the like, to identify users, devices, accounts, or the like, that may have conducted events or transactions at the identified merchant or merchant type. The proactive controls module 118 may then implement proactive controls for the identified users, accounts, devices, and the like.

For instance, the proactive controls module 118 may modify parameters associated with an identified account or device (e.g., credit card, debit card, or the like) or may instruct another device to modify parameters associated with an identified account, device, user, or the like. For instance, proactive controls module 118 may transmit an instruction (or signal including an instruction) to an account/device computing system 108 directing the account/device computing system to modify parameters associated with the account or device.

The account/device computing system 108 may include one or more processors, memory, communication interfaces, and the like, and may be configured to store and control parameters associated with user information, accounts, devices, and the like. For instance, the account/device computing system 108 may control and store account numbers, features or other parameters of a device or account (e.g., interest rate, transaction limit, or the like).

For example, the proactive controls module 118 may instruct the account/device computing system 108 to modify requirements associated with use of a device, such as requiring additional input of identifying information prior to completing or processing events associated with an identified device. For example, the system may require that biometric data (e.g., fingerprint, retinal scan, voice print, or the like) be provided prior to processing or completing an event with the identified device or account. In another example, a username and password combination or personal identification number (PIN) may be required prior to processing or completing an event with the device or account. In still other examples, the proactive controls module 118 may direct the account/device computing system 108 to modify an amount for which the device/account may be used for an event. For example, a transaction limit may be set such that the device or account cannot be used to process transactions over the transaction limit. In these examples, a notification may be transmitted to a user associated with the device or account indicating the changes being implemented. In some examples, the notification may offer additional assistance, such as an option for the user to request a new device.

In some examples, the proactive controls module 118 may transmit an instruction or signal directing the account/device computing system 108 to cancel the identified device (e.g., credit card, debit card, or the like) and reissue a new device (e.g., with a new account number, expiration date, or the like). In these examples, a notification may be transmitted to the user indicating that the device will no longer be available for use and indicating when the user can expect a substitute device to arrive.

In some examples, different proactive controls may be implemented based on a likelihood that future unauthorized activity will occur. For example, if multiple occurrences in a cluster have a common merchant, that may be a strong indicator that future or other unauthorized activity will occur with devices used at that merchant. Accordingly, strong proactive controls may be implemented, such as immediately canceling the device and issuing a replacement device. In another example, if multiple occurrences have a common type of merchant or amount, these may still be indicators of potential future unauthorized activity but not as strong as, for example, having a common merchant. Accordingly, less severe proactive controls may be implemented, such as limiting an amount of transaction, requiring additional identifying or authenticating information, or the like. In some examples, the less severe proactive controls may be implemented temporarily, while a new device is being issued to the user (e.g., a user may continue to use the device, it might not be immediately canceled, but a new device will be issued and the old device will be canceled when the replacement device is activated by the user).

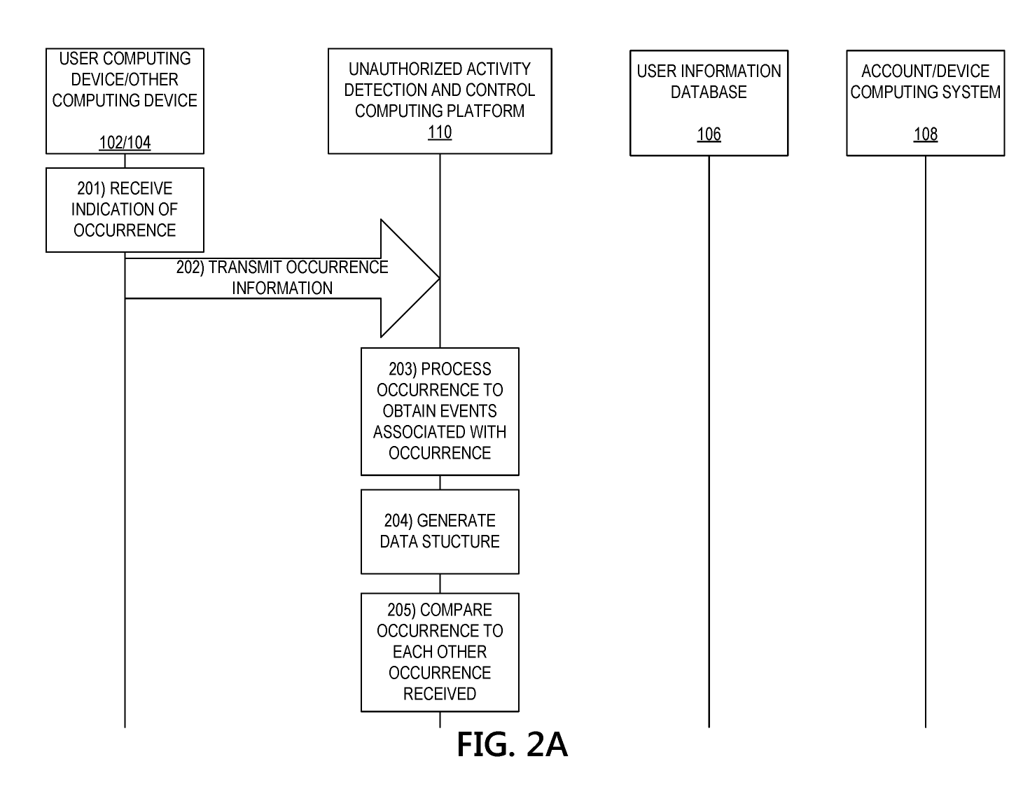

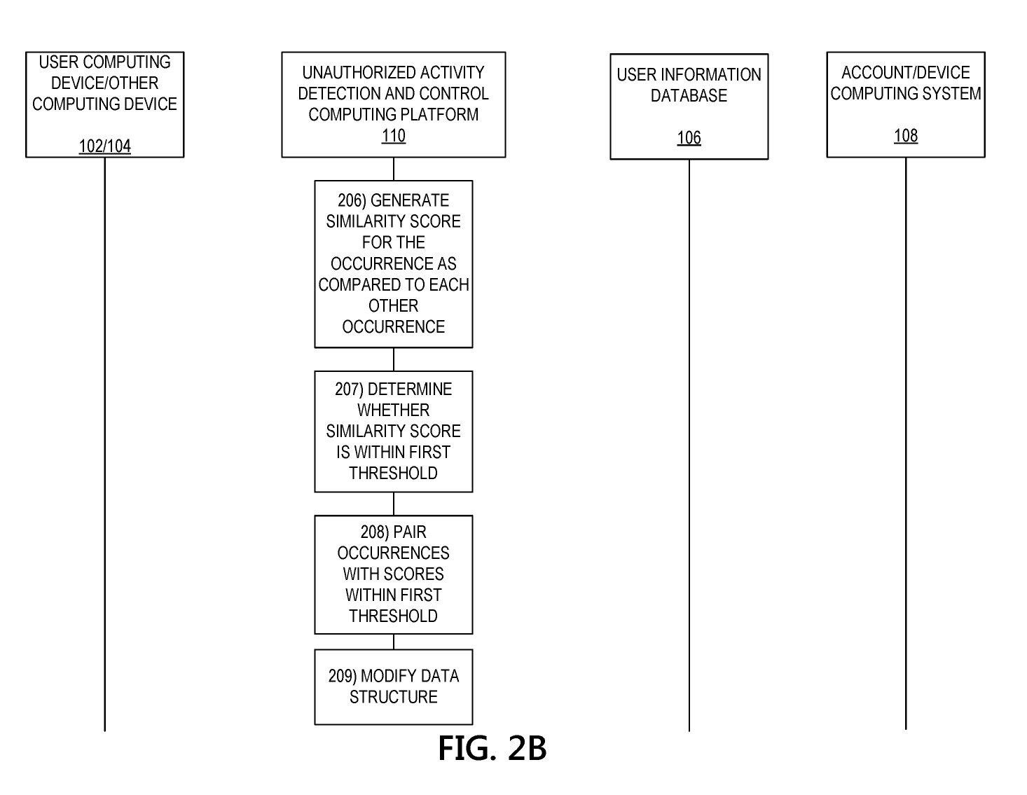

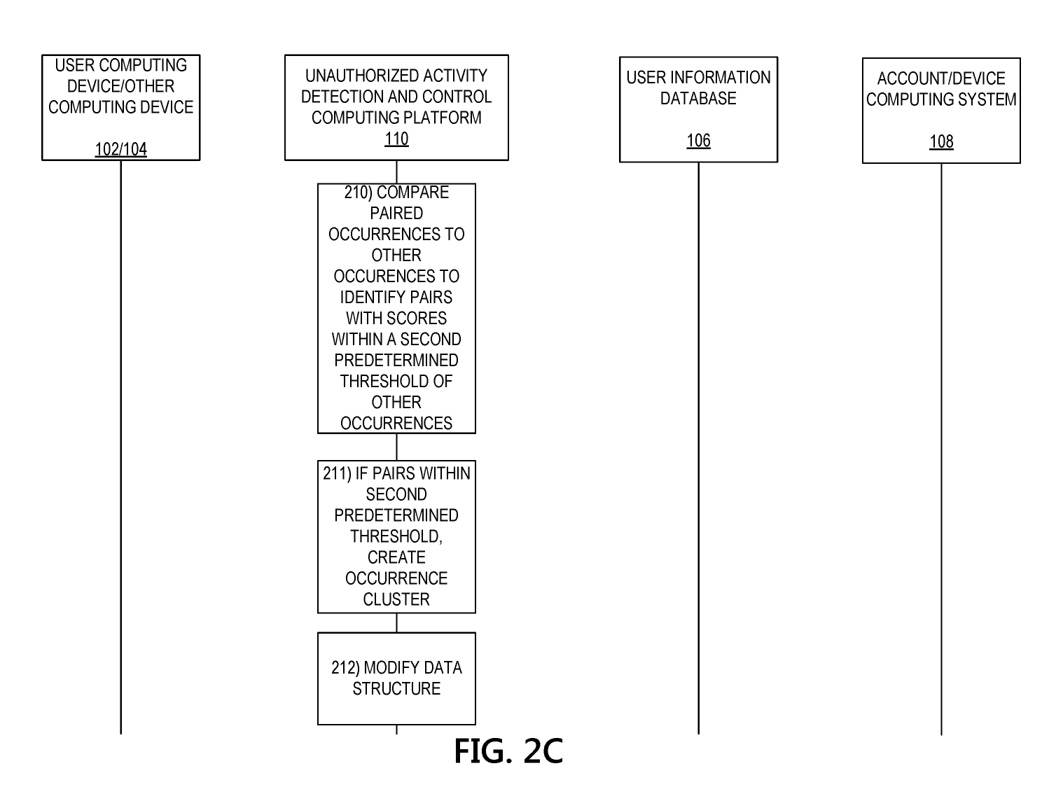

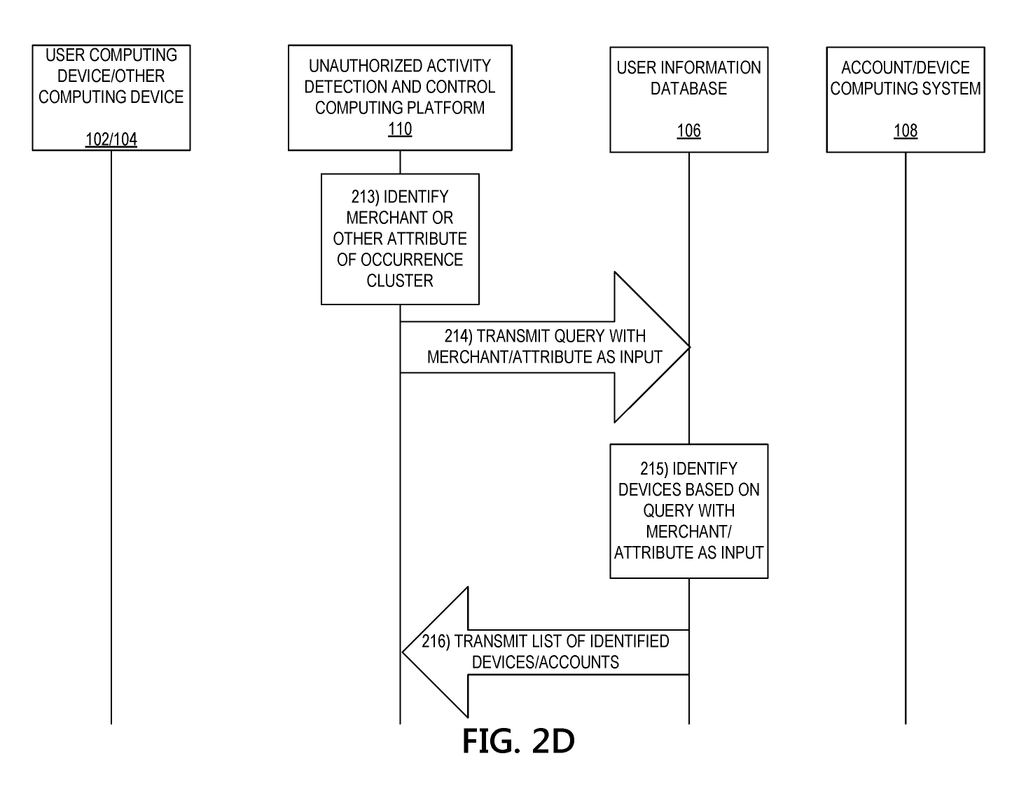

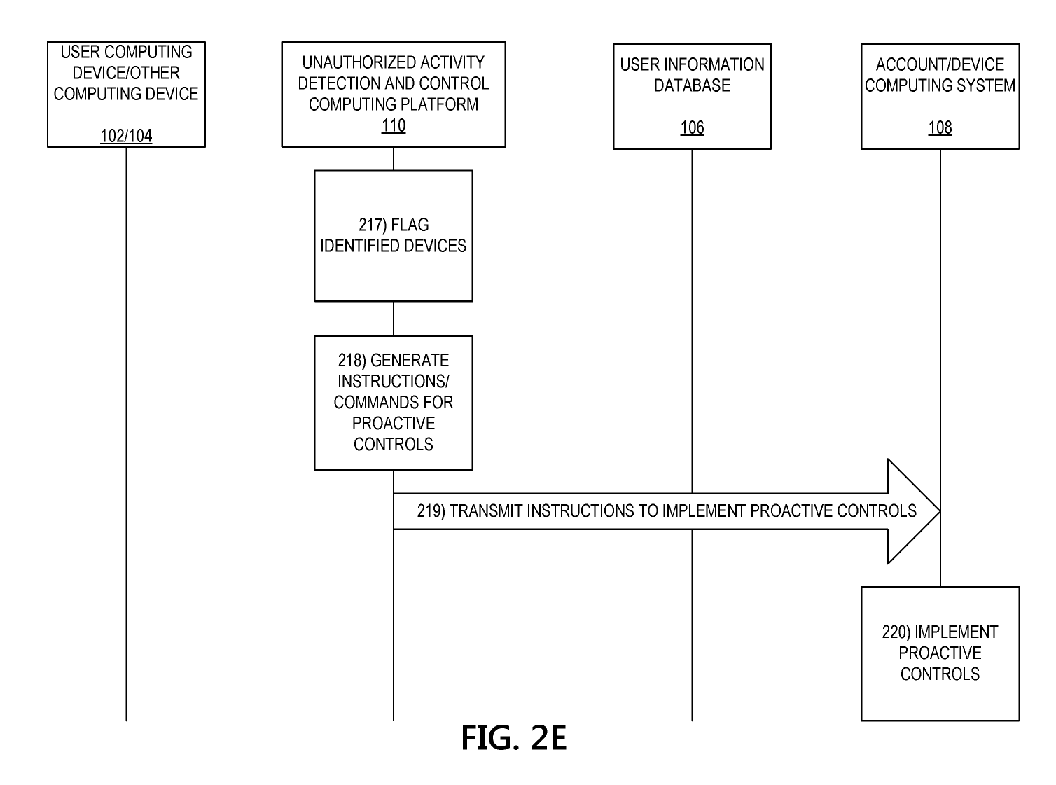

FIGS. 2A-2E illustrate one example event sequence for detecting unauthorized activity and providing proactive controls in accordance with one or more aspects described herein. The sequence illustrated in FIGS. 2A-2E is merely one example sequence and various other events may be included, or events shown may be omitted, without departing from the invention.

With reference to FIG. 2A, in step 201, an indication of an occurrence of unauthorized activity may be received from a user computing device 102, other computing device 104, or the like. In some examples, a plurality of occurrences may be received from various users, various devices, and the like. In step 202, the received occurrence information may be transmitted to the unauthorized activity detection and control computing platform 110.

In step 203, the received occurrence (and/or other occurrences received in a similar timeframe or prior to receipt of the occurrence) may be processed to identify one or more events associated with the occurrence. In step 204, a data structure may be generated to store the received occurrence(s) and events associated with each occurrence. In some examples, the data structure might not be generated in step 204 and, instead, a previously created data structure (e.g., created upon receipt of a previously occurring occurrence) may be modified to include occurrence and event data from steps 201 and 203.

In step 205, each occurrence (e.g., each received occurrence, each occurrence in the data structure, or the like) may be compared to each other occurrence (e.g., each other received occurrence, each other occurrence in the data structure, or the like). Accordingly, each occurrence may be compared to each other occurrence in a plurality of occurrences.

With reference to FIG. 2B, in step 206, a similarity score or value may be generated for the comparison of each occurrence to each other occurrence. For instance, a first occurrence may be compared to a second occurrence and a similarity score or value may be determined, as discussed above. In step 207, a determination is made as to whether a determined similarity score is within a first predefined similarity threshold. If so, the occurrences will be paired in step 208. The process may then be repeated until each occurrence has been compared with each other occurrence. Any occurrences not having a similarity score above the first predetermined threshold (e.g., any occurrences not paired with at least one other occurrence) may be removed from further processing (e.g., data deleted, moved to other data store, or the like). As indicated above, an occurrence may be paired with more than one occurrence (e.g., may have a similarity score above the first predetermined similarity threshold with more than one other occurrence).

In step 209, the data structure may be modified to store the newly created pairs of occurrences, attributes of the occurrences, and the like.

With reference to FIG. 2C, in step 210, paired occurrences may be compared to other paired occurrences (e.g., each paired occurrence may be compared to each other paired occurrence) to identify pairs within a second predetermined similarity threshold of other occurrences or pairs. In some examples, the first predetermined similarity threshold and the second predetermined similarity threshold may be the same. In other examples, the first and second thresholds may be different (e.g., a first threshold may be lower or higher than the second threshold).

In step 211, if a similarity score of a pair is within the second predetermined similarity threshold of another occurrence or pair of occurrences, the pairs (or pair and occurrence) may be combined to form an occurrence cluster. This process may be repeated until every pair is compared to each other pair. In some examples, the process may then be repeated by comparing each cluster to each other cluster until a desired number of items for further evaluation is reached. In step 212, the data structure may be modified to include the created clusters.

With reference to FIG. 2D, in step 213, a merchant or other attribute of a cluster may be identified. For instance, a merchant, merchant location, type of merchant, amount of event, or the like, may be identified as common to some or all of the occurrences in the cluster, that may be an indication of susceptibility of that merchant, type of merchant, or the like, to unauthorized activity and, as such, proactive controls should be implemented for other users having activity associated with that merchant, type of merchant, or the like. Accordingly, the identified merchant or attribute (e.g., type of merchant, location of merchant, amount of event, or the like) may be transmitted as an input in a query of user information database 106 in step 214.

In step 215, one or more devices, accounts, or the like, associated with the query input (e.g., merchant or other attribute) may be identified and, in step 216, a list of identified devices, accounts, and associated information (e.g., user associated with the account or device, contact information for the user, and the like) may be transmitted to the unauthorized activity detection and control computing platform 110.

With reference to FIG. 2E, in step 217, the proactive controls module of the unauthorized activity detection and control computing platform 110 may flag the devices, accounts, and the like. In step 218, proactive controls for the identified accounts, devices, and the like may be generated (e.g., instructions for commanding the account/device computing system 108 to modify parameters associated with the devices, accounts, or the like, may be generated). As discussed above, proactive controls may include event limits, requirements for additional identifying and/or authenticating information, cancellation of a device and reissue of a substitute device, and the like.

In step 219, the generated instructions may be transmitted to the account/device computing system 108 to direct the computing system to modify parameters associated with the identified devices, accounts, and the like, according to the generated instructions. In step 220, the account/device computing system 108 may implement the proactive controls (e.g., may execute the received instructions).

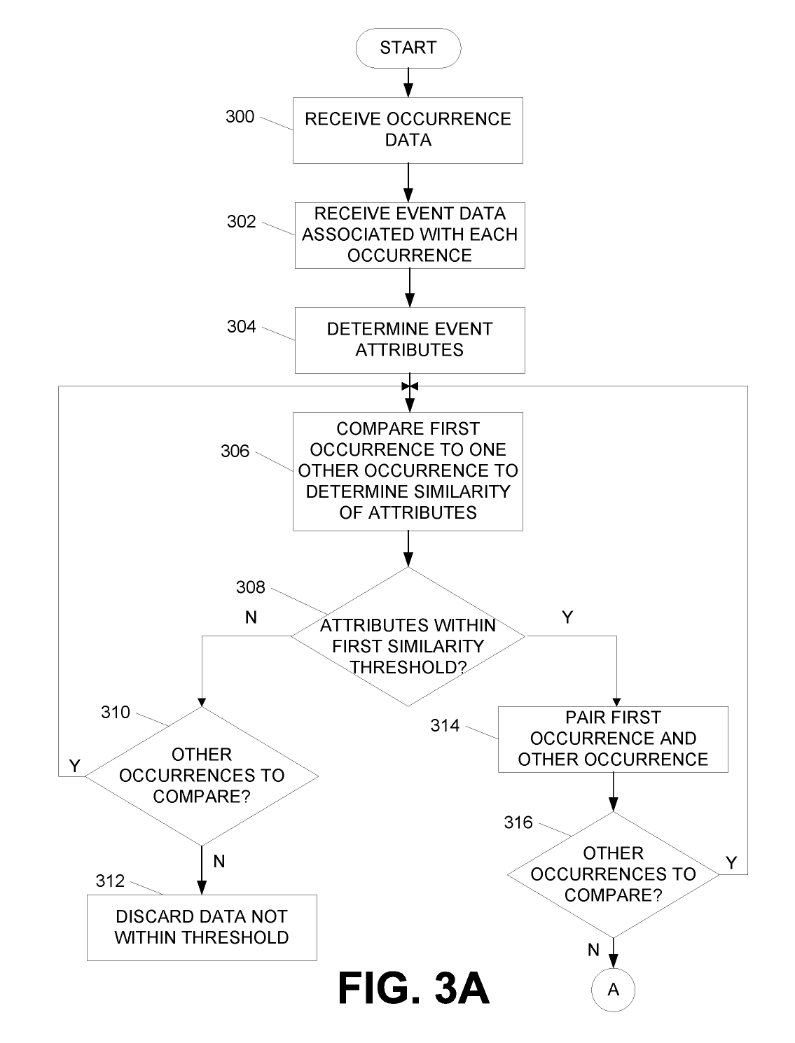

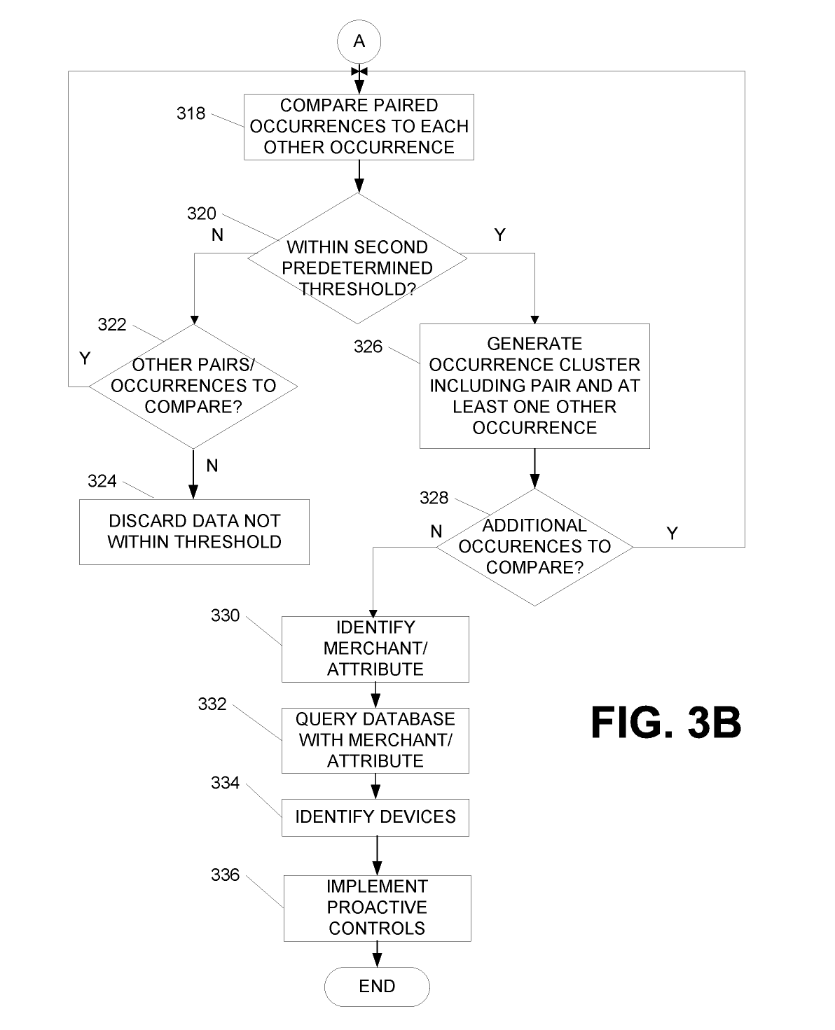

FIGS. 3A and 3B illustrate additional example processes of detecting unauthorized activity and implementing proactive controls. The various steps and processes discussed with respect to each figure may be performed in an order other than the one illustrated in the figures and one or more steps of processes may be used in combination with one or more other steps or processes shown in other figures. Nothing in the figures or associated specification should be viewed as limiting the steps of the processes described to only use in a particular order or to only use with the other steps shown and described in the respective figure of the step.

FIGS. 3A and 3B illustrate one example method of detecting unauthorized activity and implementing proactive controls according to one or more aspects described herein. In step 300, occurrence data may be received. As discussed herein, occurrence data may be received from a user computing device 102, other computing device 104, or the like. In step 302, event data associated with each occurrence may be received and/or retrieved.

In step 304, attributes of one or more events associated with each occurrence may be determined. For instance, attributes such as merchant name, merchant category or category code, location of merchant, amount of event, and the like may be identified or determined from the event data. In step 306, a first occurrence may be compared to one other occurrence to determine a similarity of attributes between the two occurrences (e.g., the first occurrence and a second occurrence). As discussed herein, the similarity may be determined by comparing attributes of each occurrence to each other to determine whether they are the same or substantially the same (e.g., same merchant name, same merchant location, or the like). A similarity score or value may be determined based on the comparison and, in step 308, a determination may be made as to whether the similarity score or value is at or above a first predetermined similarity threshold.

If not, the process may proceed to step 310 in which a determination is made as to whether there are additional occurrences available for comparison (e.g., a first occurrence may be compared to another occurrence such as a third occurrence, a different occurrence may be compared to each other occurrence, or the like). If so, the process may return to step 306 to compare the other occurrences. If not, the occurrence which is not sufficiently similar to any other occurrence may be discarded or removed from further processing (e.g., deleted, stored in a different data store, or the like).

If, in step 308, the attributes are at or above the first predetermined similarity threshold, the first occurrence and the occurrence to which it is being compared (e.g., the second occurrence) may be paired in step 314, as discussed more fully herein. In step 316, a determination is made as to whether additional occurrences are available for comparison (e.g., other occurrences to compare to the first occurrence, other occurrences to compare to other occurrences, and the like). If so, the process may return to step 306 to compare the first occurrence to another occurrence (or to compare another occurrence (e.g., third, fourth, fifth, or the like occurrence) to yet another occurrence). If not, the process may continue to step 318 in FIG. 3B.

With reference to FIG. 3B, in step 318, the paired occurrences may be compared to other pairs of occurrences and/or other occurrences to determine a similarity. As discussed above, the process for comparing pairs and occurrences may be similar to the process described herein for comparing occurrences. A similarity score or value may be determined and, in step 320, a determination may be made as to whether the similarity score is at or above a second predetermined similarity threshold. In some examples, the first and second predetermined similarity thresholds may be the same value for the threshold. In other examples, they may be different thresholds or values.

If, in step 320, the similarity score is not at or above the second predetermined threshold, the process may continue to step 322 in which a determination may be made as to whether there are additional pairs for comparison (e.g., a first pair compared to another occurrence or pair, a second, third, fourth, or the like, pair to compare to other pairs or occurrences, and the like). If so, the process may return to step 318 to perform additional comparisons. If not, data that does not meet the second similarity threshold may be discarded (e.g., deleted or removed from further processing).

If, in step 320, the comparison indicates that the similarity score is at or above the second predetermined similarity threshold, an occurrence cluster including the pair(s), other occurrence, and the like, above the threshold in step 326. In step 328, a determination is made as to whether additional pairs are available for comparison. If so, the process may return to step 318 to compare the first pair or other pairs to each other pair.

If not, the process may continue at step 330 by identifying a merchant or other attribute common among the clustered occurrences. In step 332, the identified merchant or other attribute may be used as input in a query of a user information database 106. The query may be used to identify one or more devices, accounts, and the like, that may be susceptible to unauthorized activity because they include events associated with the merchant or attribute in step 334. For instance, if Merchant A is identified as a merchant at which several occurrences of unauthorized activity in a cluster occurred, Merchant A may be used as input in a query to identify other users, devices, accounts, and the like, having transactions or events with Merchant A. Those other users, devices, accounts, and the like, might not have had occurrences of unauthorized activity but may be susceptible to occurrences because of the events conducted with Merchant A. Accordingly, in step 336, one or more proactive controls may be implemented for the identified devices, accounts, or the like.

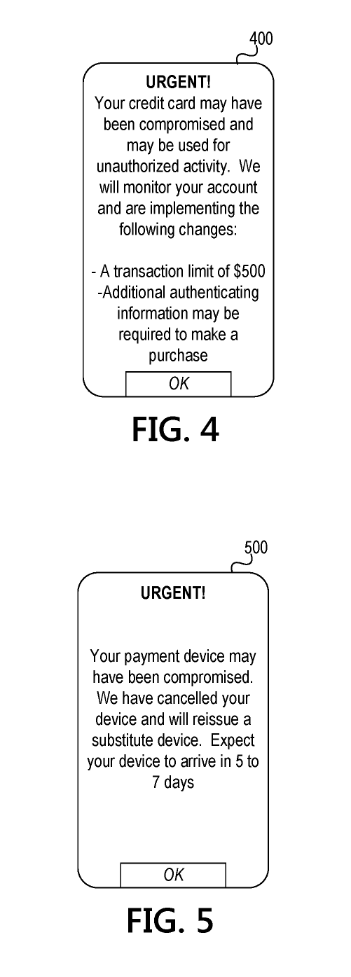

FIG. 4 illustrates one example user interface that may be generated and provided to a user according to one or more aspects described herein. The user interface 400 includes a notification that one or more proactive controls have been implemented on a payment device associated with a user. The user interface 400 includes a list of the proactive controls that have been implemented. In some examples, more or fewer proactive controls may be implemented. In some examples, the proactive controls such as a transaction limit, required additional authentication, or the like, may be temporarily put in place (e.g., for a predetermined time period) while a user awaits receipt of a replacement device (e.g., a substitute debit card, credit card, or the like). In some examples, the user interface 400 may further include an option available for selection that would present additional options to a user (e.g., modify the proactive controls being implemented, request a new device, or the like). In some arrangements, selection of the option to view additional options would cause a second user interface to be displayed to the user including the additional options.

FIG. 5 illustrates another example user interface that may be generated and presented to a user in accordance with one or more aspects described herein. The user interface 500 includes a notification that the device used by or associated with a user may have been compromised (e.g., may be susceptible to unauthorized activity). Accordingly, the device may be canceled or deactivated such that the device is no longer eligible to be used to conduct events. The notification also includes an indication that a replacement or substitute device is being generated and will be sent to the user. In some examples, the user interface 500 may include an indication of an expected arrival date of the replacement device.

Below is one example implementation of aspects described herein. The below is example is intended to be just one example implementation and should not be viewed as limiting any aspects to only this example.

An entity issuing a payment device, such as a debit or credit card, may receive a report of an occurrence of unauthorized activity. The occurrence may be entered into the unauthorized activity detection and control system and a plurality of transactions associated with the occurrence may be identified (e.g., transactions made using the debit or credit card). This occurrence may be compared to each other occurrence within the system to determine similar occurrences. For example, if this occurrence was with Merchant X, this occurrence may be paired with other occurrences that took place at Merchant X. Once the occurrence has been compared to each other occurrence, the generated pairs may be compared to other pairs or occurrences. Accordingly, this occurrence (Occurrence 1) may be paired with another occurrence (Occurrence 2) and the pair (Pair 1) may be compared to other pairs or occurrences. For example, if Occurrence 1 is also paired with Occurrence 5 (e.g., based on merchant name or other attribute, such as type of merchant, location of merchant, amount of transaction, or the like), Occurrence 5 may be compared to Occurrence 2 to determine whether they are sufficiently similar. If so, an occurrence cluster may be generated including Occurrence 1, Occurrence 2, and Occurrence 5. This process may continue until a desired number of clusters are generated, until each pair has been compared, or the like.

The generated cluster including, for example, Occurrences 1, 2 and 5 may be analyzed to determine a common factor, such as merchant name, merchant type, merchant location, amount of transaction, or the like. This common factor or attribute may then be used to query a database to identify other users, accounts, debit cards, credit cards, or the like, associated with the common factor (e.g., having transactions at the merchant, at the type of merchant, or the like). Those accounts, debit cards, credit cards, or the like, may be flagged and one or more proactive controls may be implemented.

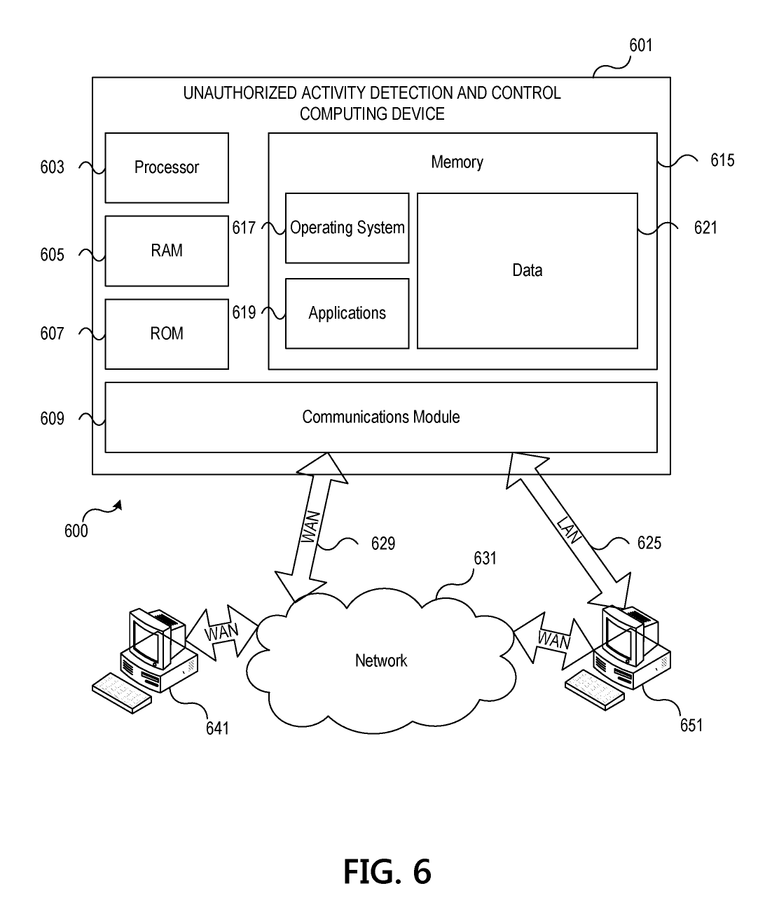

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include unauthorized activity detection and control computing device 601 having processor 603 for controlling overall operation of unauthorized activity detection and control computing device 601 and its associated components, including random-access memory (RAM) 605, read-only memory (ROM) 607, communications module 609, and memory 615. Unauthorized activity detection and control computing device 601 may include a variety of computer readable media. Computer readable media may be any available media that may be accessed by unauthorized activity detection and control computing device 601, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 601.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on unauthorized activity detection and control computing device 601. Such a processor may execute computer-executable instructions stored on a computer-readable medium.

Software may be stored within memory 615 and/or storage to provide instructions to processor 603 for enabling unauthorized activity detection and control computing device 601 to perform various functions. For example, memory 615 may store software used by unauthorized activity detection and control computing device 601, such as operating system 617, application programs 619, and associated database 621. Also, some or all of the computer executable instructions for unauthorized activity detection and control computing device 601 may be embodied in hardware or firmware. Although not shown, RAM 605 may include one or more applications representing the application data stored in RAM 605 while unauthorized activity detection and control computing device 601 is on and corresponding software applications (e.g., software tasks) are running on unauthorized activity detection and control computing device 601.

Communications module 609 may include a microphone, keypad, touch screen, and/or stylus through which a user of unauthorized activity detection and control computing device 601 may provide input, and may also include one or more of a speaker for providing audio output and a video display device for providing textual, audiovisual and/or graphical output. Computing system environment 600 may also include optical scanners (not shown). Exemplary usages include scanning and converting paper documents, e.g., correspondence, receipts, and the like, to digital files.

Unauthorized activity detection and control computing device 601 may operate in a networked environment supporting connections to one or more remote computing devices, such as computing devices 641 and 651. Computing devices 641 and 651 may be personal computing devices or servers that include any or all of the elements described above relative to unauthorized activity detection and control computing device 601.

The network connections depicted in FIG. 6 may include local area network (LAN) 625 and wide area network (WAN) 629, as well as other networks. When used in a LAN networking environment, unauthorized activity detection and control computing device 601 may be connected to LAN 625 through a network interface or adapter in communications module 609. When used in a WAN networking environment, unauthorized activity detection and control computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

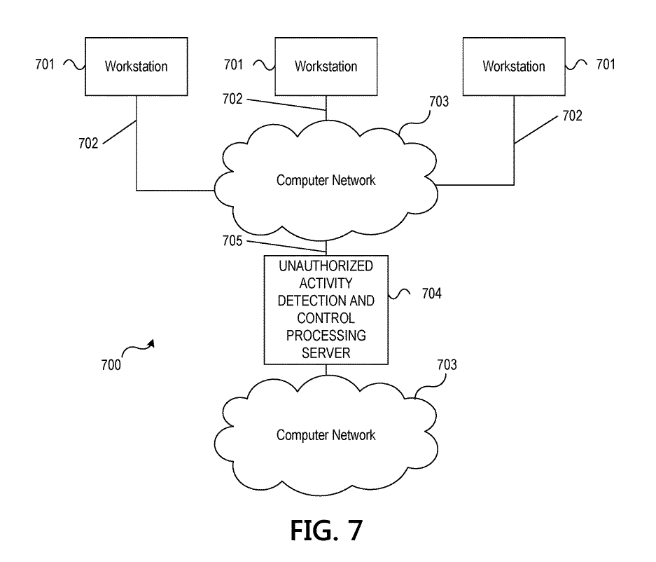

FIG. 7 depicts an illustrative block diagram of workstations and servers that may be used to implement the processes and functions of certain aspects of the present disclosure in accordance with one or more example embodiments. Referring to FIG. 7, illustrative system 700 may be used for implementing example embodiments according to the present disclosure. As illustrated, system 700 may include one or more workstation computers 701. Workstation 701 may be, for example, a desktop computer, a smartphone, a wireless device, a tablet computer, a laptop computer, and the like, configured to perform various processes described herein. Workstations 701 may be local or remote, and may be connected by one of communications links 702 to computer network 703 that is linked via communications link 705 to unauthorized activity detection and control processing server 704. In system 700, unauthorized activity detection and control processing server 704 may be any suitable server, processor, computer, or data processing device, or combination of the same, configured to perform the functions and/or processes described herein. Server 704 may be used to process the instructions received from one or more devices, detect unauthorized activity, implement proactive controls, and the like.

Computer network 703 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 702 and 705 may be any communications links suitable for communicating between workstations 701 and unauthorized activity detection and control processing server 704, such as network links, dial-up links, wireless links, hard-wired links, as well as network types developed in the future, and the like.

As discussed herein, the arrangements described provide efficient and accurate methods for reducing a number of occurrences of unauthorized activity for evaluation by clustering occurrences based on their similarity to other occurrences. Accordingly, the amount of computing resources and other resources needed to evaluate occurrences is drastically reduced (e.g., rather than evaluating 1,000,000 occurrences, the system may reduce the number of occurrences for evaluation to less than 100, less than 50, or the like, occurrences for evaluation). This also may reduce the amount of memory and storage required to evaluate the occurrences.

Reducing the number of occurrences for evaluation not only increases accuracy associated with evaluating the occurrences, but also permits the system to more quickly identify potential future occurrences of unauthorized activity and take action (such as implementing one or more proactive controls) more quickly, to avoid or prevent the potential future occurrences.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers or platforms and one or more networks. The functionality may be distributed in any manner, or may be located in a single computing device (e.g., a server, a client computer, and the like), or across multiple computing devices. In such arrangements, any and/or all of the above-discussed communications between modules of the computing platform may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. An unauthorized activity detection and control computing platform, comprising:
at least one processor;
a communication interface communicatively coupled to the at least one processor; and
at least one memory storing computer-readable instructions that, when executed by the at least one processor, cause the unauthorized activity detection and control computing platform to:
receive a plurality of occurrences of unauthorized activity;
identify a plurality of events associated with each occurrence of the plurality of occurrences of unauthorized activity;
generate a data structure including the plurality of occurrences and the plurality of events;
compare a first occurrence of the plurality of occurrences to a second occurrence of the plurality of occurrences to determine a first similarity rating;
determine whether the first similarity rating is within a first predefined threshold of similarity;
responsive to determining that the first similarity rating is within the first predefined threshold, pairing the first occurrence and the second occurrence and generating a data element associated with the pairing of the first occurrence and the second occurrence;
storing the data element in the generated data structure;
compare the paired first occurrence and second occurrence with a third occurrence to determine a second similarity rating;
determine whether the second similarity rating is within a second predefined threshold;
responsive to determining that the second similarity rating is within the second predefined threshold, grouping the first occurrence, second occurrence, and third occurrence into an occurrence cluster;
identify a merchant associated with the occurrence cluster;
query a user database to identify devices used at the identified merchant associated with the occurrence cluster; and
implementing proactive controls for the identified devices.

2. The unauthorized activity detection and control computing platform of claim 1, further including instructions that, when executed, cause the unauthorized activity detection and control computing platform to compare each occurrence of the plurality of occurrences to each other occurrence of the plurality of occurrences to determine a similarity rating for each comparison.

3. The unauthorized activity detection and control computing platform of claim 2, further including instructions that, when executed, cause the unauthorized activity detection and control computing platform to:
remove from further processing any occurrence not having a similarity score within the first predefined threshold of similarity of any other occurrence.

4. The unauthorized activity detection and control computing platform of claim 3, wherein removing from further processing includes one of: deleting the occurrence and transferring the occurrence to another storage device.

5. The unauthorized activity detection and control computing platform of claim 1, wherein implementing proactive controls includes requiring a user to input additional identifying or authenticating information when the identified device is used to process an event.

6. The unauthorized activity detection and control computing platform of claim 5, wherein the additional identifying or authenticating information includes biometric data of a user associated with the identified device.

7. The unauthorized activity detection and control computing platform of claim 5, wherein the additional identifying or authenticating information includes a username and password combination of a user associated with the identified device.

8. The unauthorized activity detection and control computing platform of claim 1, wherein implementing proactive controls further includes deactivating the identified devices and issuing replacement devices to users associated with the identified devices.

9. The unauthorized activity detection and control computing platform of claim 1, wherein implementing proactive controls includes limiting an amount of an event that may be processed using the identified devices.

10. A method, comprising:
receiving, by an unauthorized activity detection and control computing platform, a plurality of occurrences of unauthorized activity;
identifying, by the unauthorized activity detection and control computing platform, a plurality of events associated with each occurrence of the plurality of occurrences of unauthorized activity;
generating, by the unauthorized activity detection and control computing platform, a data structure including the plurality of occurrences and the plurality of events;
comparing, by the unauthorized activity detection and control computing platform, a first occurrence of the plurality of occurrences to a second occurrence of the plurality of occurrences to determine a first similarity rating;
determining, by the unauthorized activity detection and control computing platform, whether the first similarity rating is within a first predefined threshold of similarity;
responsive to determining that the first similarity rating is within the first predefined threshold, pairing, by the unauthorized activity detection and control computing platform, the first occurrence and the second occurrence and generating a data element associated with the pairing of the first occurrence and the second occurrence;
storing, by the unauthorized activity detection and control computing platform, the data element in the generated data structure;
comparing, by the unauthorized activity detection and control computing platform, the paired first occurrence and second occurrence with a third occurrence to determine a second similarity rating;
determining, by the unauthorized activity detection and control computing platform, whether the second similarity rating is within a second predefined threshold;
responsive to determining that the second similarity rating is within the second predefined threshold, grouping, by the unauthorized activity detection and control computing platform, the first occurrence, second occurrence, and third occurrence into an occurrence cluster;
identifying, by the unauthorized activity detection and control computing platform, a merchant associated with the occurrence cluster;
querying, by the unauthorized activity detection and control computing platform, a user database to identify devices used at the identified merchant associated with the occurrence cluster; and
implementing, by the unauthorized activity detection and control computing platform, proactive controls for the identified devices.

11. The method of claim 10, further comparing, by the unauthorized activity detection and control computing platform, each occurrence of the plurality of occurrences to each other occurrence of the plurality of occurrences to determine a similarity rating for each comparison.

12. The method of claim 11, further including removing from further processing, by the unauthorized activity detection and control computing platform, any occurrence not having a similarity score within the first predefined threshold of similarity of any other occurrence.

13. The method of claim 12, wherein removing from further processing includes one of: deleting the occurrence and transferring the occurrence to another storage device.

14. The method of claim 10, wherein implementing proactive controls includes requiring a user to input additional identifying or authenticating information when the identified device is used to process an event.

15. The method of claim 14, wherein the additional identifying or authenticating information includes biometric data of a user associated with the identified device.

16. The method of claim 14, wherein the additional identifying or authenticating information includes a username and password combination of a user associated with the identified device.

17. The method of claim 10, wherein implementing proactive controls further includes deactivating the identified devices and issuing replacement devices to users associated with the identified devices.

18. The method of claim 10, wherein implementing proactive controls includes limiting an amount of an event that may be processed using the identified devices.

19. One or more non-transitory computer-readable media storing instructions that, when executed by at least one computer system comprising at least one processor, memory, and a communication interface, cause the at least one computer system to:
receive a plurality of occurrences of unauthorized activity;
identify a plurality of events associated with each occurrence of the plurality of occurrences of unauthorized activity;
generate a data structure including the plurality of occurrences and the plurality of events;
compare a first occurrence of the plurality of occurrences to a second occurrence of the plurality of occurrences to determine a first similarity rating;
determine whether the first similarity rating is within a first predefined threshold of similarity;
responsive to determining that the first similarity rating is within the first predefined threshold, pairing the first occurrence and the second occurrence and generating a data element associated with the pairing of the first occurrence and the second occurrence;
storing the data element in the generated data structure;
compare the paired first occurrence and second occurrence with a third occurrence to determine a second similarity rating;
determine whether the second similarity rating is within a second predefined threshold;
responsive to determining that the second similarity rating is within the second predefined threshold, grouping the first occurrence, second occurrence, and third occurrence into an occurrence cluster;
identify a merchant associated with the occurrence cluster;
query a user database to identify devices used at the identified merchant associated with the occurrence cluster; and
implementing proactive controls for the identified devices.

20. The one or more non-transitory computer-readable media of claim 19, further including instructions that, when executed, cause the at least one computer system to compare each occurrence of the plurality of occurrences to each other occurrence of the plurality of occurrences to determine a similarity rating for each comparison.

21. The one or more non-transitory computer-readable media of claim 20, further including instructions that, when executed, cause the at least one computer system to:
remove from further processing any occurrence not having a similarity score within the first predefined threshold of similarity of any other occurrence.

22. The one or more non-transitory computer-readable media of claim 21, wherein removing from further processing includes one of: deleting the occurrence and transferring the occurrence to another storage device.

23. The one or more non-transitory computer-readable media of claim 19, wherein implementing proactive controls includes requiring a user to input additional identifying or authenticating information when the identified device is used to process an event.

24. The one or more non-transitory computer-readable media of claim 23, wherein the additional identifying or authenticating information includes biometric data of a user associated with the identified device.

25. The one or more non-transitory computer-readable media of claim 23, wherein the additional identifying or authenticating information includes a username and password combination of a user associated with the identified device.

26. The one or more non-transitory computer-readable media of claim 19, wherein implementing proactive controls further includes deactivating the identified devices and issuing replacement devices to users associated with the identified devices.

27. The one or more non-transitory computer-readable media of claim 19, wherein implementing proactive controls includes limiting an amount of an event that may be processed using the identified devices.
